(19) United States
(12) Patent Application Publication
(10) Pub. No.: US 2025/0084314 A1
(43) Pub. Date: Mar. 13, 2025

(54) Method and Apparatus for the Pyrolysis of Polymers

(71) Applicant: Front Row Engineering Ltd, Waterfall (IE)

(72) Inventor: Gavin Duffy, Waterfall (IE)

(21) Appl. No.: 18/728,221

(22) PCT Filed: Jan. 9, 2023
(86) PCT No.: PCT/EP2023/050347

§ 371 Date: Jul. 11, 2024

(30) Foreign Application Priority Data
Jan. 12, 2022 (GB) 2200332.1
Sep. 23, 2022 (GB) 2213963.8

(51) Int. Cl. C10B 49/22; B01D 3/14; C10B 53/07; C10B 57/06

(52) U.S. Cl. CPC C10B 49/22; B01D 3/143; C10B 53/07; C10B 57/06

(57) ABSTRACT

The invention describes a method and apparatus for pyrolysis of polymeric material, comprising an injection nozzle (52) adapted to receive a melted polymeric feed (62) from an extruder (2), wherein the melted polymeric feed (62) has a reduced viscosity and is pre-heated to a pre-defined temperature at which pyrolysis starts to occur; and to atomize and disperse the melted polymeric feed (62) evenly across a heat carrying material into a fluidized bed reactor (10), by combining the melted polymeric feed (62) with a pressurised atomization gas (61) wherein the reduced viscosity and atomization gas facilitates even dispersion of the melted polymeric feed.

### FIELD OF THE INVENTION

This invention relates to a method and apparatus for the pyrolysis of polymers, and in particular to a method and apparatus for converting polymers into one or more liquid and gaseous hydrocarbon products.

### BACKGROUND OF THE INVENTION

Plastic pyrolysis has failed to become a viable alternative to incineration and landfill. Many attempts have been made at converting plastic waste into fuels using pyrolysis on an industrial scale. Previous attempts have failed because of the plants being economically unviable. The main reasons for their economic failure are, the inability to scale the plant, the low quality of products, low yield of products and energy inefficiencies.

Previous attempts at industrial scale plastic pyrolysis have failed to scale their pyrolysis reactors above 500 kilograms per hour. In the prior art this inability to scale has resulted in multiple reactors being used to scale to meet the required throughput. Scaling the process in this manner fails to take advantage of economies of scale which is a key factor in making the process viable. These solutions are both impractical and expensive and have been a major roadblock in the scale up of plastic pyrolysis. Therefore, there is a need within the art to produce a reactor which is capable of processing high throughputs of polymer to create an economically viable process.

Previous attempts at converting plastic by pyrolysis into a hydrocarbon product of high enough quality so that it can be used as a feedstock to produce virgin quality plastics classifying the process as chemical recycling have mostly failed. Most oils produced from plastic pyrolysis in the past have been of relatively low quality and have been mostly used as fuels for burners. This has caused the process to be highly criticised saying it is only one step removed from incineration. Contamination that is common in plastic waste streams which ends up in the product oil prevents products meeting the strict specifications of the petrochemical industry.

There is a need within the art for an effective way to remove these harmful contaminants in order to produce hydrocarbon products that can meet the specifications of the petrochemical industry in order to close the loop on plastic recycling.

Plastic production is set to quadruple by the year 2050 which is predicted to result in plastics' share of global oil consumption increasing from 6% in 2012 to 20% in 2050 and plastics' share of the carbon budget increasing from 1% in 2012 to 15% in 2050. If the current plastic recycling rate remains the same the ratio of plastic waste to fish by weight in the ocean in 2050 will be 1:1. There is a global need for a scalable chemical recycling process that can both solve the current plastic waste crisis and provide a sustainable source of feedstock to produce plastic.

Another consideration is that switching the feedstock for steam crackers from hydrocarbons derived from fossil fuels to products from plastic pyrolysis could drastically reduce the carbon emissions of the petrochemical industry. The steam cracker which produces light olefins, such as ethylene and propylene which are the building blocks for plastic, is the single most energy-consuming process in the chemical industry. The steam cracker furnace consumes approximately 65% of the total process energy and accounts for approximately 75% of the total exergy loss of olefin production. If a way can be found to produce olefins without the need of a steam cracker furnace it would result in a major reduction in global carbon emissions.

Current plastic pyrolysis plants have low yields of product per weight of plastic feedstock processed. The two main reasons for this are that plastic pyrolysis plants are extremely energy inefficient; this causes a high proportion of their products to be used to heat their process. Another major reason for the poor yields is that there is no real market for the char product that is produced, so this char is a waste product of the process. Typically, pyrolysis plants are not able to sell the gaseous products of their plants because they contain a mixture of different components which makes them less valuable, and lack a method to transport these fuels for sale. This results in all the gaseous fuels being burnt on-site even if there is no requirement for them to be burnt to heat the process. There is a need within the art to make the gaseous products saleable; and it would be desirable to find a way to bypass the steam cracker section in the production of olefins.

An object of the present invention is to provide an improved method and apparatus for the pyrolysis of waste polymer material for example polyolefin plastic waste or polystyrene plastic waste, that overcomes the abovementioned problems with the prior art.

### SUMMARY OF THE INVENTION

According to a first aspect of the present invention there is provided an apparatus for pyrolysis of polymeric material, comprising an extruder comprising a plurality of counter rotating screws, the extruder being adapted to receive an input polymeric feed and to pre-heat the input polymeric feed, wherein the pre-heating includes shear heating the input polymeric feed with the counter rotating screws to reduce viscosity of the input polymeric feed; and
an injection nozzle adapted to: receive the melted polymeric feed from the extruder, and to spray, atomize and disperse the melted polymeric feed into a reactor, by combining the melted polymeric feed with a pressurised atomization gas.

The injection nozzle comprises an outlet for the melted polymeric feed, and this injection nozzle outlet is preferably at least 2 mm wide to reduce the risk of blockage. The outlet may be at least one square, oval or circular hole, or a slot; a slot means that the outlet is greater in one direction than in the orthogonal direction, and the width of a slot means the width in the shorter direction. A slot has the advantage that it is less likely to become blocked by impurities in the feedstock. Such a slot may extend around the periphery of the fluidised bed reactor so that polymer is sprayed from different directions; indeed it may extend around the entire circumference of the periphery. The slot may be of width between 3 mm and 12 mm, more preferably between 4 mm and 10 mm, for example 5 mm or 6 mm.

The high-pressure atomisation gas may be combined with the melted polymeric feed either before or after the melted polymer flows out of the nozzle outlet. For example the atomisation gas may be introduced into the melted polymer before it reaches the outlet from the extruder, or between the outlet from the extruder and an inlet to the injection nozzle, or within the injection nozzle before it reaches the injection nozzle outlet, or by forming one or more jets of atomisation gas that impact with the melted polymer after it has passed through the injection nozzle outlet. Hence in one embodiment the injection nozzle comprises a first outlet for the melted polymeric feed and a second outlet for the atomization gas, the first and second outlet ports being arranged such that the corresponding flow paths collide.

The extruder may be adapted to mix a high boiling point product with the input polymeric feed to further reduce the viscosity of the polymeric feed.

In a second aspect the invention provides a method for pyrolysis of polymeric material, comprising feeding a melted polymeric feed through an extruder to an injection nozzle, wherein the melted polymeric feed has a reduced viscosity and is pre-heated in the extruder; and the injection nozzle atomizing and dispersing the melted polymeric feed into a reactor, by combining the melted polymeric feed with a high-pressure atomization gas, wherein the reduced viscosity facilitates even dispersion of the melted polymeric feed.

The polymeric material may be pre-heated in the extruder to a pre-defined temperature at which pyrolysis starts to occur, or to a lower temperature at which the melted polymeric material can be sprayed. The reactor may be a fluidised bed reactor and may comprise a heat carrying material, which may comprise a catalyst. The heat-carrying material may flow upwards in the fluidised bed reactor, and it may circulate, for example through a regenerator. The injector nozzle may spray the melted polymer evenly across the flowing heat carrying material.

Hence, by way of example, the injection nozzle may comprise a first outlet for the melted polymeric feed and a second outlet for the atomization gas, the first and second outlet ports being arranged such that the corresponding flow paths collide.

The extruder may also be adapted to: convert water and halogen contaminants in the input polymeric feed to water vapour and contaminated vapours during pre-heating; the extruder defining one or more outlets to expel the water vapour and contaminated vapours, wherein the apparatus is adapted to pull a vacuum on the melted polymeric feed at at least one such outlet to aid in the removal of the contaminants; and the extruder defines at least one inlet port to receive a catalyst, so the catalyst is mixed with the melted polymeric feed to neutralise halogens; and the extruder is adapted to pump the melted polymeric feed into the injection nozzle.

The extruder comprises a plurality of counter rotating screws adapted to operate at a high screw speed to impart a high shear force on the input polymeric feed such that the input polymeric feed is pre-heated to a temperature ranging from 250° C. to 375° C. in absence of oxygen. The shear force reduces the viscosity of the polymer, and increases the temperature. A twin screw extruder is therefore suitable for this purpose, and may include blocks specifically designed to apply kneading or shear to the feedstock, as well as blocks to move the feedstock through the extruder. Typically, twin screw extruders are run at a screw speed of 300 RPM but they can also be run as low as 100 RPM. The screw speed however also affects the power consumption of the extruder. It may be impractical for a high throughput extruder to have a screw speed over 600 RPM. So in the present invention the screw speed may be above 200 RPM, and may be above 400 RPM; the crucial requirement is to obtain a sufficiently low viscosity to be able to spray the melted polymer.

Pre-heating the feedstock to a temperature of approximately 250° C. to 375° C. in the extruder removes contaminants from the feedstock upstream of the reactor. The apparatus may be adapted to pull vacuum on the melted polymer at a vent from the extruder to aid in the removal of the contaminants. These contaminants are removed to a treatment system that typically combusts the contaminated stream and then cools the resulting flue gas before sending it to a scrubber that neutralises any contaminants.

In one embodiment, which would process a high amount of PVC polymer waste, the contaminated vaporised stream from the extruder would be sent to a treatment system which would first combust the contamination stream. Following combustion, the stream would be sent to an adsorber which would convert the chlorine to hydrochloric acid for sale.

Preferably the extruder is able to mix a catalyst or chemical reagent such as calcium hydroxide with the polymeric feed to increase the removal efficiency of any halogens like chlorine or bromine that may be contained in the feed.

As indicated above, the extruder pumps the molten polymer to the injection device which is designed to atomise or spray the polymer by combining it with high pressure steam or gas, so it is sprayed into the reactor. The reactor is preferably a fluidised bed reactor adapted to heat the atomized polymeric feed using heat carrying material in the absence of oxygen to break down the atomized polymeric feed into hydrocarbon vapour and a solid carbon product.

The injection nozzle may be located towards a bottom of the fluidised bed reactor, and may comprise: a first passage having an inlet for receiving the melted polymeric feed, and an outlet narrower than the inlet for outputting a thin stream of melted polymeric feed into the fluidised bed reactor; and second and third passages provided at either sides of the first passage, each having an inlet for receiving atomisation gas, and an outlet for directing the atomisation gas towards the thin stream of melted polymeric feed, wherein the atomisation gas collides with the melted polymeric feed to cause dispersion of small droplets of the melted polymeric feed evenly across the circulating heat carrying material.

It is evident that the atomization of the polymeric feed provides a greater surface area to the heat carrying material for breaking down the polymeric feed into hydrocarbon vapour and solid carbon product.

In another aspect of the invention, an apparatus for treating plastics by pyrolysis in a fluidised bed reactor containing a fluidised bed of particles of heat-carrying material also comprises a cyclone located at a top of the fluidised bed reactor and adapted to separate the heat-carrying material and solid carbon product from a gaseous hydrocarbon product, wherein a gas stream leaves the top of the cyclone and enters into a top portion of a steam stripper and a solid particles stream leaves from the bottom of the cyclone and enters into a bottom portion of the steam stripper.

Steam is provided to the steam stripper to separate and desorb hydrocarbon product adsorbed onto the heat carrying material, so enhancing product recovery.

In each aspect of the invention the apparatus preferably further comprises a regenerator adapted to combust the solid carbon product on or with the heat-carrying material, wherein the combustion of the solid carbon product leads to reheating of the heat-carrying material to a requisite temperature, before transfer of the heat-carrying material back to the fluidised bed reactor.

In each aspect of the invention there may be a distillation column or condensing system downstream of the steam stripper adapted to condense and separate the hydrocarbon product into different liquid fractions and a gaseous syngas stream.

Downstream of such a distillation column or condensing system there may be a gas liquefier to condense and separate the C2 to C4 products contained in the gaseous syngas stream. Liquefaction makes these products easier to transport. For example such liquefied short-chain products may be transported to a plant that incorporates a steam cracker, to be combined with products that come from the steam cracker.

Furthermore downstream of such a gas liquefier may also be a steam reforming reactor adapted to process the hydrogen, carbon monoxide and methane stream that is not condensed in the C2 to C4 products, to generate additional hydrogen.

There may also be a hydrogen separation device adapted to separate hydrogen from resulting uncondensed syngas stream exiting the gas liquefier or reformer.

In each case where there is a regenerator, the apparatus may further comprise a steam system to capture waste heat produced during pyrolysis of polymeric material, wherein hot flue gas produced from the regenerator flows through a heat exchanger which produces steam which is used in the process as an atomisation gas and as fluidisation medium in the fluidised bed reactor.

In any case in which hydrogen is generated, the apparatus may further comprise a hydrotreatment unit configured to treat liquid products with the generated hydrogen.

In each apparatus that includes an extruder, there may also be a contamination treatment system adapted to receive the contaminated vapours including hydrocarbon vapour and halogen vapour from the extruder; and to combust the contaminated vapours to cause the chlorine and bromine to form HCl and HBr respectively and the hydrocarbon vapour to form carbon dioxide, wherein the combustion is performed in a vessel that is made of a corrosion resistant material.

In the context of industrial scale plastic pyrolysis plants, the ability to scale up the throughput is a significant issue. Fluidised bed type reactors assist in solving this problem by putting the plastic in direct contact with the heat carrying material, which is typically catalyst or sand, providing a much-increased heat transfer rate. Spraying molten polymer evenly across a stream of continuously flowing hot heat-carrying material, rather than feeding in solid plastic with a screw auger, avoids the risk of agglomeration of the bed. The flowing heat-carrying material continuously carries the polymer feed away and transfers its heat to the polymer which causes the polymer to crack into shorter chain hydrocarbons. As the polymer feed rate increases the circulation rate of the heat-carrying material can be increased in proportion to the polymer feed which enables the reactor to scale and take advantage of the economies of scale.

Fluidized bed technology is a well-developed technology used in many different industries. However, spraying polymer into a reactor is not straightforward because polymers are non-Newtonian fluids so they act completely differently to the materials typically processed by these reactor types. The viscosity of the polymer does not reduce as much as a Newtonian fluid would with increasing temperature. If the viscosity of the feed is not decreased enough it will not be possible to spray the plastic feedstock. Using heat alone to decrease the viscosity of the feed is unsatisfactory for processing polymers. Most polymers are shear-thinning non-Newtonian fluids which means their viscosity decreases when increasing shear force is applied to them. In the present invention the extruder heats and melts the plastic by applying shear, which reduces its viscosity and increases its temperature.

Preferably the polymer is heated to a temperature below that at which pyrolysis starts to occur.

Preferably the extruder applies a high shear rate on the polymer to get the viscosity as low as possible. This is typically done by using a twin screw extruder with a screw design to impart a high shear force on the polymer. The extruder typically has a very high screw speed which also increases the shear force applied to the extruder. This gives the polymer an extremely low viscosity which grants the feed the required fluid dynamics to enable the injection device to make the polymer form a spray.

Preferably the injection device first thins the polymer out into a thin stream and orientates the polymer up the riser to aid with the fluid dynamics. The injection nozzle combines the polymer with a high velocity, high pressure and high temperature atomisation gas which is typically steam or recycled syngas which are both by-products of the process. In one embodiment the nozzle will collide the polymer and a gas stream to spray into small droplets.

In a preferred embodiment, the extruder is adapted to feed the feedstock to the reactor at a constant flow rate, viscosity, temperature and pressure to the injection nozzle. The injection nozzle is able to atomise and disperse the melted plastic evenly across the heat carrier material providing excellent mixing. This even coating and excellent mixing leads to a lower amount of the heat carrying material being required and thus resulting in a smaller reactor and a greatly reduced energy consumption.

In the present invention the mixture of char, heat carrying material and hydrocarbon vapours from the reactor will flow to a cyclone which separates the hydrocarbon vapour from the heat carrying material or char. The heat carrying material and char will fall down into a steam stripping tower which will remove the entrained hydrocarbon products in the bed material, desorb any remaining hydrocarbons from the catalytic bed material, and crack any remaining plastic that may have escaped the reactor without cracking. This will prevent the loss of product, as instead of the hydrocarbon products burning in the regenerator they will be recovered from the steam stripping tower. If too many hydrocarbons reach the regenerator this could result in the temperature range going outside of the optimal range and require a reduction in throughput to maintain control of the process. A loss of catalyst activity can occur if excessive temperatures are present in the regenerator, as this can destroy the catalyst's crystalline structure. The tower may be adapted to supply 1-10 kg of steam for every 1,000 kg of circulating catalyst.

In the present invention a solid carbon product called char or coke is combusted to increase the temperature of the heat-carrying material, and so a dual fluidised bed type reactor is used. One side of the dual reactor pyrolyzes the polymer waste and the other side is responsible for the combustion of char on the heat carrying material. This side is often referred as a regenerator when using catalyst as the heat carrying material, or reheater when using sand as the heat carrying material. If a catalyst is being used as the heat carrying material the char can reduce the catalyst's activity and it needs to be removed. Therefore following the stripper the heat carrying material can be routed to a regenerator where air is added to combust the char. After the char is combusted and the heat is transferred to the heat-carrying material it is recirculated back to the bottom of the reactor. The burning of the char from the catalyst also reactivates the catalyst.

The hot flue gas produced from the regenerator flows through a heat exchanger which produces steam which can be used in the process as an atomisation and lift gas in the reactor. The excess steam in this process can be used to drive equipment or sent to a steam turbine which produces electricity from this steam.

A steam cracker is a known component of a conventional plant to make polymers from oil. Typical specifications for feedstock to a steam cracker is 1 ppm halogen content. However when performing pyrolysis of plastics the product oil may not comply with this limitation. Flame retardants which are a common additive in plastic typically include halogens like bromine and chlorine. A small amount of these additives can knock the product oil out of specification. Other additives also add unwanted oxygenates and nitrates to the hydrocarbon products. The present invention seeks to remove this contamination by exploiting the weaker chemical bonds between the contamination and the polymer. Polymers contain a carbon and hydrogen backbone that contaminants like bromine and chlorine attach to. The carbon-carbon and carbon-hydrogen bonds are stronger than the carbon-bromine and carbon-chlorine bonds. This invention seeks to exploit this difference in bond strength by heating the feed to a point at which the bulk of the carbon-carbon and carbon-hydrogen bonds do not break, but above the point at which the bonds of the contamination break. The contamination is withdrawn to a treatment process so it does not end up in the final products.

This invention may pull a vacuum on the extruder which increases the quantity of contamination removed. Although not a large proportion of the polymer feedstock is cracked along with the contamination, it still can be sizable especially if trying to reach high removal efficiencies, as anywhere from 0 to 10% of the total feed polymer may be cracked along with the contamination. As this invention aims to achieve large throughputs this amount of hydrocarbon being removed with the contamination represents a huge amount of wasted hydrocarbon and energy. It is difficult to separate this hydrocarbon from the contamination and because the removed stream contains high levels of chlorine and bromine it is highly corrosive and difficult to handle. The cracked hydrocarbons include a significant quantity of wax which makes the stream very difficult to handle especially when trying to condense out the hydrocarbon components.

This invention aims to utilise this valuable hydrocarbon contained in the contamination stream by combusting it in a vessel constructed of a material resistant to the corrosive chlorine and bromine that form acid components. The heat from the hot flue gases generated from the combustion are recovered using a heat recovery boiler that is also constructed from a material resistant to corrosion from the contamination. This heat is integrated with the plant's steam cycle. The cooled flue gases are then sent to a caustic scrubber where the caustic neutralises the acidic chlorine and bromine-containing molecules. The resulting gas from the scrubber can then be processed by the plant's emission abatement system without fear of it corroding any of the equipment.

The ability to remove this contamination enables this invention to take poor quality mixed polymer feed and convert it into hydrocarbon oils and gases that can meet the stringent standards required for steam cracker feeds. Hence this invention can achieve recycling status, as this requires the polymer feed to be turned back into new polymers or high value chemicals. In contrast if plastic pyrolysis only produces low quality burner fuels the process is considered as only one step removed from incineration.

Typically, syngas represents anywhere from 10 to 20% of the total product of a plant targeting liquid products. As only 5% of the products of pyrolysis are required to heat the reaction and for heat loss, it is unnecessary to burn all the syngas. This invention utilises the char product rather than the syngas to fuel the process. The efficiency of the dual fluidised bed at heating the polymer feedstock, the preheating of the feedstock, and the efficient design results in this invention producing excess heat that the heat recovery system can utilise. The syngas product is therefore not required to fuel the plant. The syngas product produced contains the following molecules:

| Component | Boiling Point (° C.) |
|---|---|
| Hydrogen | −252.9 |
| Carbon monoxide | −191.5 |
| Methane | −161.6 |
| Ethane | −89 |
| Ethylene | −103.7 |
| Propane | −42 |
| Propylene | −47.6 |
| Butane | −1 |
| Butene | −6.3 |
| C5+ | 36.1 |

Although the proportions of the relevant molecules change when reaction parameters and feedstocks are changed, it has been found that the composition of the syngas is very similar to the product stream from the pyrolysis section of a steam cracking furnace.

Another problem in using the products of plastic pyrolysis is that they contain a high proportion of olefins. Although the purpose of a steam cracker is to convert paraffins into olefins, having a high amount of olefins in the feed causes coking in the steam cracker. The steam cracker converts paraffins into olefins which are the building blocks of most of the most common plastics. As mentioned above, steam cracking for the production of light olefins, such as ethylene and propylene, is the single most energy-consuming process in the chemical industry—the pyrolysis section of steam crackers alone consumes approximately 65% of the total process energy and approximately 75% of the total exergy loss. Bypassing the pyrolysis section of the steam cracker would save the huge quantities of energy required to crack the paraffins into olefins. And bypassing the pyrolysis section of the steam cracker avoids the issue with olefins in the product stream, as in fact they are the most valuable components of the stream. Converting waste plastic directly into the monomers of plastic is a process known as monomer recycling which has failed to reach commercial scale. The output product stream from the steam cracker in a petrochemical facility is very similar to the syngas stream leaving the top of the distillation column or condensing system in the plastic pyrolysis plant of the present invention. This invention aims to solve this problem by feeding this syngas to downstream of the pyrolysis section of a steam cracker where the syngas which contains a mixture of paraffins and olefins ranging in carbon chain length C2 to C4 can be separated into its individual components.

Locating the plastic pyrolysis plant next to a steam cracker plant may not be practical because the low bulk densities of plastic feedstock may make the logistics of transporting the vast quantities of this feedstock to the steam cracker site not practical. As the polymer feedstock is dispersed and not concentrated in certain locations, it makes more sense to locate the pyrolysis plants also in dispersed areas, and transport the syngas to the steam cracker sites. It is not practical to pipe this syngas via pipeline over any substantial distance. To transport this syngas, it will need to be liquified. The syngas contains molecules that condense out at different temperatures. In order to condense out all of the syngas it would be necessary to pressurise and cool the gas down to an extremely low temperature as hydrogen, the lowest boiling point component, has a boiling point of −260° C. This would be uneconomic. In most steam crackers the hydrogen, carbon monoxide and methane are burnt as a low value fuel gas because of difficulties in separation. The ethylene, propylene and butene are the high value products and the ethane, propane and butane are recycled as feedstock for the process. To condense out the C2 to C4 stream the gas does not have to be pressurised as high and does not have to be cooled so much as the lowest boiling point component ethylene has a boiling point of −105° C. To further reduce the energy consumption of the liquification, the cooling temperature can be raised so as to liquefy just the C3 and C4 components. As the hydrogen, carbon monoxide and methane components are low value products that are not desired by the steam cracker process it is not worth transporting them to the petrochemical plant. This invention therefore aims to convert the syngas stream into a highly saleable C2 to C4 liquid that can be easily transported to a steam cracker plant capable of separating C2 to C4 paraffins or olefins. The liquid once transported to the steam cracker facility can be easily tied into downstream of the pyrolysis section of the steam cracker furnace. This will greatly reduce the energy consumption and carbon intensity of plastic production and will find a way to finally recycle mixed low quality waste plastic into virgin quality plastic thus finally making the monomer recycling of plastic a reality.

The hydrogen, carbon monoxide and methane stream that is not condensed can processed separately. This stream leaving the gas condensing system is pressurised and if passed through a suitable membrane the hydrogen contained in this mixed gas stream can be extracted and concentrated. The residual methane and carbon monoxide stream can be combusted to provide additional heat for the process.

The liquid products from the plastic pyrolysis process contain a high proportion of olefins, and this product would have to be hydrotreated to meet the standards of the petrochemical industry. This previously has been uneconomical at small scale in pyrolysis facilities because of the large capital and operating cost means high throughput are a necessity to make it economical. This invention, as an option, may therefore use hydrogen from the syngas product for the hydrotreatment of the liquid products.

### BRIEF DESCRIPTION OF THE DRAWINGS

An apparatus for the pyrolysis of waste material in accordance with an embodiment of the present invention will now be described, by way of example only, with reference to:

FIG. 1, which is a schematic drawing of the apparatus for the pyrolysis of waste polymers;

FIG. 2a, which is a schematic drawing of the injection nozzle in the apparatus of FIG. 1;

FIG. 2b, which is a part-sectional and part-perspective view of an injection nozzle equivalent to that of FIG. 2a;

FIG. 2c, which is a schematic drawing of the arrangement of reactor bottom and injection nozzle in the apparatus of FIG. 1; and

FIG. 3, is a schematic drawing of the syngas reforming apparatus for the apparatus of FIG. 1.

### DETAILED DESCRIPTION OF THE DRAWINGS

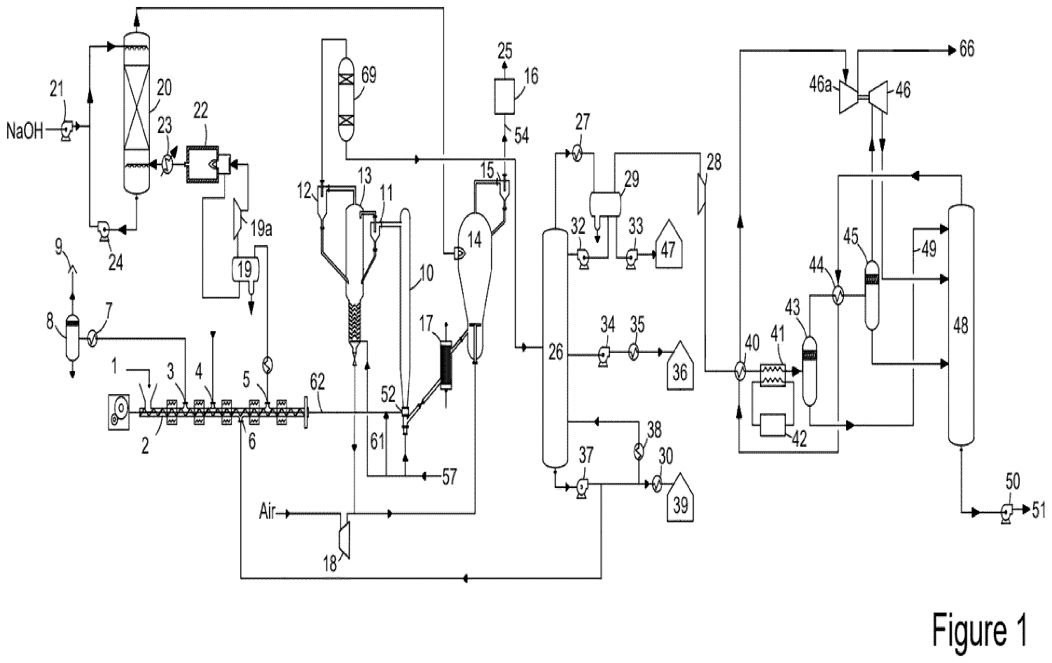

The apparatus for the pyrolysis of polymers, in accordance with a preferred overall embodiment of the present invention is schematically illustrated in FIG. 1.

The apparatus is adapted to heat waste feedstock to an elevated temperature at two stages within the process in the absence of oxygen, breaking the long-chained polymers into shorter hydrocarbon chains to produce a vapour which can be subsequently condensed to produce products, such as heavy gas oil, light gas oil, naphtha, and syngas, and the remaining solids are removed and combusted to heat the process. Once produced these products are separated from each other by distillation.

The waste plastic feedstock 1 is initially processed so that it can be delivered to the extruder 2 in a form which is readily manageable such as crumb, pellet or flake. The processed feedstock 1 may be stored in a silo from which it may be discharged for example by means of an inclined screw conveyor, into a hopper. The hopper is preferably mounted directly on top of an extruder 2 and provides additional storage for the feedstock 1.

The extruder 2, is adapted to serve a number of functions, the primary being the pre-heating of the feedstock to a temperature of approximately 250° C. to 375° C. in the absence of oxygen. The extruder 2 achieves this temperature elevation by shear heating the feedstock using two counter rotating screws in the extruder which directly transfer the energy from the drive into the feedstock.

The second function of extruder 2 is the reduction of the viscosity of the plastic feedstock which is crucial for the later atomization of the plastic feedstock. Plastics are non-Newtonian fluids meaning their viscosity does not remain constant with different shear rates and in the case of polymers decreases when increasing shear stress is applied to them. The extruder can reduce the plastic feedstock viscosity by increasing both the temperature and shear rate, hence the extruder 2 apparatus is ideal for reducing plastics' viscosity.

Many attempts have been made at trying to reduce the viscosity of the plastic by merely heating but although it reduces the viscosity of the plastic it fails to reduce it to the level required for adequate dispersion and atomization.

The viscosity of the plastic feedstock is additionally lowered by combining the feedstock with a heavy gas oil recycle stream. The heavy gas oil recycle stream is pumped into the extruder 2 at point 6 in FIG. 1 which mixes the lower viscous oil with the liquid feedstock thereby diluting the feedstock and ultimately reducing its viscosity.

This feed system decreases the chances of agglomeration of molten plastic in the fluidized bed reactor. The agglomeration of the waste plastic would happen when plastic, char and heat carrying material agglomerate inside the reactor. This would result in a reduction of the movement of the bed material, leading to defluidisation, and heat transfer between the bed material and plastic feed would be significantly reduced. The extruder gives the plastic excellent fluid dynamic properties that enables the plastic and heat carrying material to circulate in the reactor.

The final function of the extruder 2 is the removal of both water and contamination. The main contamination concern is halogens like chlorine and bromine as they may result in the formation of hydrochloric (HCl) acid and hydrobromic acid (HBr) which can corrode apparatus, and also such halogens reduce the quality of the final oil products. The removal of water and chlorine will be achieved in the extruder 2 through the application of two methods. Firstly, since carbon-bromine bonds crack at temperature over 150° C. and carbon-chlorine bonds break at temperature over 250° C. and water has evaporation temperature of 100° C., these contaminants may be liberated out of the extruder 2 (this method of removing contaminations is sometimes referred to as stepwise pyrolysis). Three nozzles exist on top of the extruder 2 located at the points 3, 4 and 5 for the purpose of removing contaminants. Two of the nozzles 3 and 5 function to remove contaminant vapours. Water vapours and other contaminants such as glue exit the first nozzle 3 and the higher temperature chlorine and bromide contaminants exit the second nozzle 5. The nozzle 3 sends the water vapour to condenser 7 which condenses the water into a liquid. Following the condenser 7, the liquid water enters a knockout drum 8 to separate the liquid from any gas.

The contaminated vapours exiting the nozzle 5 are sent to a treatment process. Approximately 1% of the plastic feedstock will be pyrolyzed and exits at nozzle 5 as a hydrocarbon vapour along with the halogen contamination; this will occur at a temperature of 280° C. to 350° C. The vapour stream is cooled to remove the condensable components, the condensed vapour falls into a knockout drum 19 to separate any water from the hydrocarbon oils. The hydrocarbon oil from the knockout drum 19 is pumped to a burner 22 and the water is sent for treatment. The uncondensed vapour is sucked by vacuum pump 19a, and is fed to the burner 22 and is combusted which causes the chlorine and bromine to form HCl and HBr and the hydrocarbon gas to form carbon dioxide. The burner 22 and associated equipment are constructed from corrosion resistant material to ensure the acidic compounds do not corrode the burner. The gases produced by the burner 22 are then cooled in a cooler 23 prior to being sent to a scrubber 20. The HCl and HBr is removed by the caustic solution in scrubber 20, which neutralizes the HCl and HBr. The vapour is contacted with the caustic solution through a packing material, and the caustic solution is recirculated through the scrubber 20 using a pump 24; additional sodium hydroxide solution may be added to the recirculating caustic solution by a pump 21. The neutralized vapour can be sent to the regenerator 14 or processed by the site's flue gas treatment without fear of corrosion.

Nozzle 4 on the extruder 2 enables a solid such as a catalyst or chemicals such as but not to limited zeolite, alumina, magnesium hydroxide or calcium hydroxide (slaked lime) to be added. The solids added will react with the halogen and other contaminants present in the plastic feedstock and form less harmful substances. For example, slaked lime will react with any chlorine remaining in the plastic feedstock to form calcium chloride.

The plastic feedstock exits the extruder 2 as a liquid with a low viscosity and at a temperature below that at which the bulk of pyrolysis occurs, and enters the injection nozzle 52. The injection nozzle 52 sprays the molten plastic into a fluidised bed reactor (FBR) 10 containing a particulate heat-carrying material. The FBR 10 is a dual reactor, comprising a riser (into which the molten plastic is injected) and a regenerator 14.

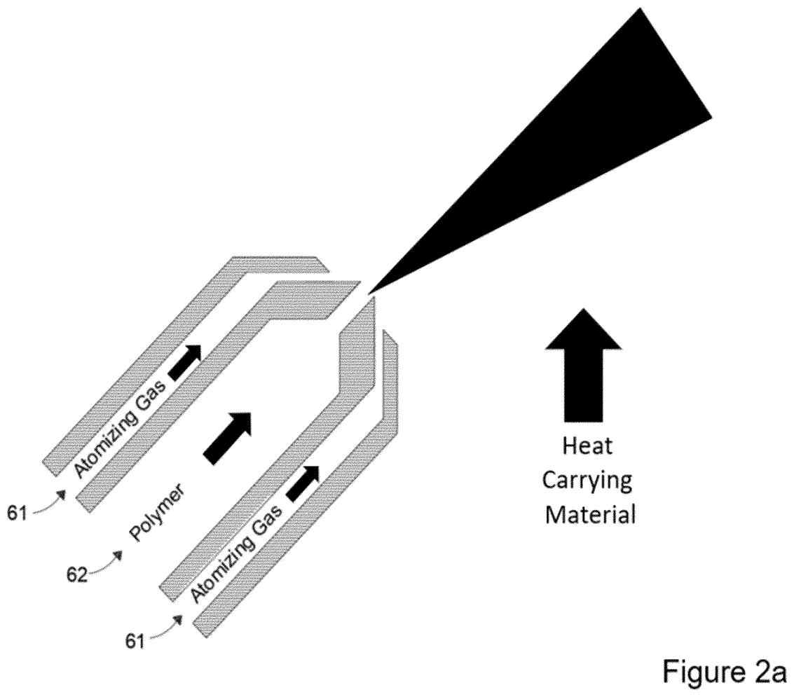

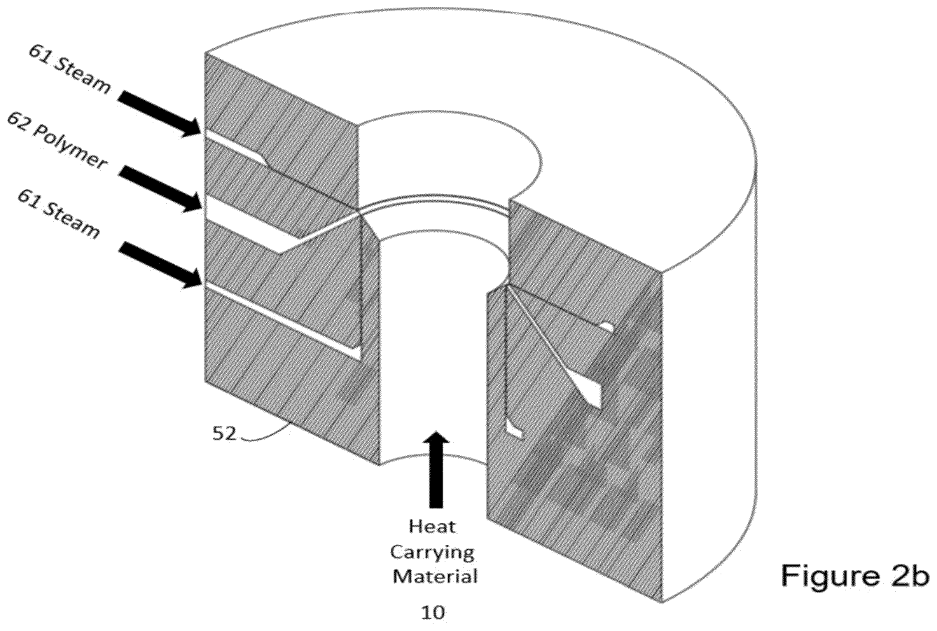

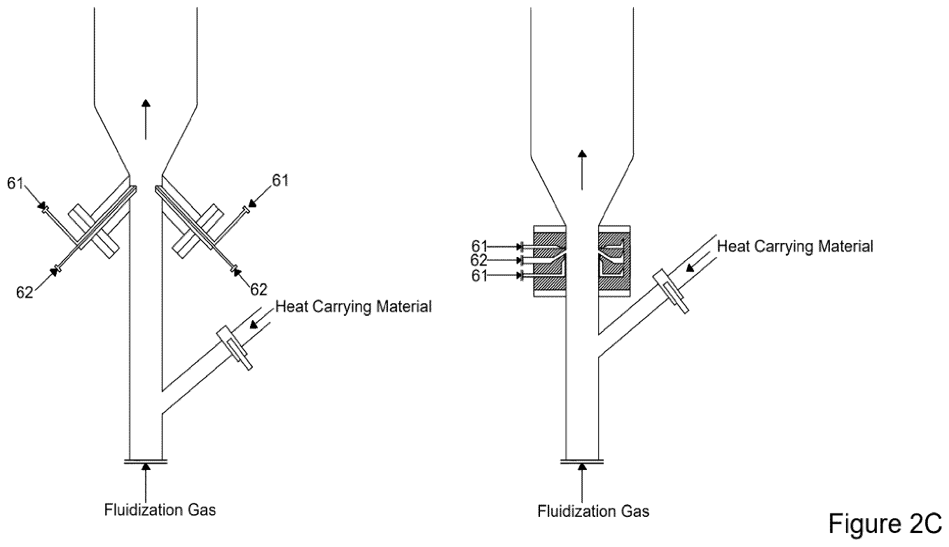

Referring now to FIG. 2a, this shows a preferred design of an injection nozzle 52 and the direction of the flowing heat-carrying material. The injection device first thins the polymer out into a thin stream and orientates the polymer up the reactor to aid with the fluid dynamics of the reactor. The injection nozzle 52 will combine high velocity, high pressure and high temperature atomisation gas 61, which is typically nitrogen or steam that is a by-product of the process, with the molten polymer. The injection nozzle 52 will collide the polymer stream 62 and an atomisation gas stream 61 to atomize the polymer into droplets.

Referring now to FIG. 2b, this shows the bottom part of the cylindrical wall of the riser, that is the first part of the fluidised bed reactor 10, along the bore of which the particles of heat-carrying material are arranged to flow by an up-flowing lift gas which is usually superheated steam. The bore defines a step, at which the flow path becomes wider. The melted polymer 62 from the extruder 2 is fed by a pipe into the wall, leading to a channel within the wall that extends all round, concentric with the bore. A gap extends from this channel to the face of the bore at the inner edge of the step, tapering down to a slot of width 5 mm that extends all around the bore. The polymer emerges initially as a sheet through this slot; the gap leading to this slot is inclined from the horizontal, so the initial flow direction of this polymer sheet is about 45° above the horizontal.

At the same time an atomising gas 61, high pressure superheated steam in this case, is introduced through two pipes that lead to two similar channels in the wall, all around, and concentric with the bore, above and below the channel for the polymer. These communicate with gaps that taper down to narrow slots of a width between 0.01 mm to 1 mm around the face of the bore, just above and just below the slot for the polymer, and so just at the inner edge of the step, and oriented in horizontal and vertical directions respectively. The jets of atomising gas collide with the top and bottom faces of the melted polymer sheet, and break up the sheet of melted polymer into ligaments and then droplets that spray into the fluidised bed of the reactor 10.

To help make the polymer spray it is important to get the atomising gas velocity is as high as possible. This is achieved by supplying high pressure gas 61 to the nozzle, and by tapering the gap that leads to the slot at the face of the bore. The reduction of the width increases the gas velocity while decreasing the flowrate so that the flowrate is kept to under 20% of the plastic flowrate.

Referring now to FIG. 2c, this shows how the two options for incorporating the injection device into the reactor. The drawing on the right of shows how an injection device similar to the device in FIG. 2b can be incorporated into the reactor. Another option for the injection device is shown in the drawing on the left where multiple singular injection devices can be inserted into the reactor.

Referring again to FIG. 1, the injection nozzle 52 will thus atomize or spray the polymer feed 62 into the first side of the FBR 10 which contains the up flowing stream of hot heat carrying material which is typically catalyst or sand. The atomization of the plastic feedstock will provide a larger surface for the particles of heat carrier to crack the plastic feedstock. The main benefit of atomizing the plastic feedstock is to prevent clumping or agglomeration of molten plastic and heat carrying material.

A stream 57 of pressurised high-temperature steam acts as an atomizing gas 61 for the nozzle 52 and lift gas for FBR 10 and at a lower pressure may be provided to a stripper 13. The lift gas will enter the bottom of FBR 10 and blow the heat-carrying particles which are at a temperature between 400° C. and 1000° C. in the reactor riser into a cyclone 11. The injection nozzle 52 is located towards the bottom of the reactor riser and sprays the polymer feed into the up-flowing stream of heat carrying material and thereby cracking the plastic into shorter carbon chain products. The lift gas blows hydrocarbon vapour produced from cracking the plastic up through the reactor 10 and into the cyclone 11 located at the top of the reactor 10.

The cyclone 11 separates the solids such as heat carrying material, catalyst, slaked lime, chemical reagent or solid residue, from the hydrocarbon vapour gas. Cyclone 11 therefore has two separate streams exiting: the gas stream leaving the top of the cyclone 11 enters the top of a stripper 13 while the solid particles stream leaves the bottom and enters the bottom of the stripper 13.

Fluidization gas stream 61 enters the bottom of the stripper 13, and the stream permeates through the solid particles which gather at the bottom of the stripper 13. The fluidization gas stream 61 desorbs any hydrocarbon products that have been absorbed into the particle heat carrier. The fluidization gas stream 61 additionally allows any trapped hydrocarbon vapours to escape from the solid particles that have gathered at the bottom of the stripper 13. The trapped vapours exit through the top of the stripper 13 where they enter a cyclone 12 designed to separate finer particles from the vapour, and the remaining vapour then flows into a fixed bed reactor 69.

The primary function of the fixed bed reactor 69 is to remove any remaining halogens or contamination from the hydrocarbon vapour. The hydrocarbon vapour will pass through the fixed bed reactor 69 which contains catalysts or chemical reagents. These catalysts or reagents will react with the halogens in the hydrocarbon and will trap the halogens in the fixed bed reactor 69.

The solid particles that gathered at the bottom of the stripper 13 exit at the bottom of the stripper 13 through a valve which maintains a barrier between the stripper 13 and the regenerator 14, and a compressed air stream from a compressor 18 blows the solid particles into the bottom of the regenerator 14. In another embodiment the stripper 13 may be located at an elevation higher than the regenerator 14 so the solid particles may fall by gravity from the stripper 13 to the regenerator 14.

The regenerator 14, which is the second side of the dual FBR, combusts the solid carbon produced from cracking the plastic by introducing air to the regenerator 14. The regenerator 14 also may be supplemented by a fuel product produced by the process. The combustion of the char from the heat carrier results in the reheating of the heat carrier back up to the required temperature. The exhaust exiting the top of regenerator 14 enters a cyclone 15 which separates any solid particles from the flue gas. The resulting flue gas stream 54 flows into a waste heat boiler 16 which transfers the heat of the flue gas to the steam cycle. The cooled flue gas 25 flows to an emissions treatment system (not shown).

The reheated heat carrying material subsequently exits the bottom of regenerator 14 through a cooler 17 which reduces the heat carrying material's temperature in the event the temperature is too great for re-entering the FBR 10. The heat carrying material is then fed into the bottom of the fluidised bed reactor 10.

A distillation column 26 fractionates the vapour exiting the fixed bed reactor 69 in a continuous process. The vapour enters the column 26 and a large amount of the vapour is condensed and separated according to its boiling point. The column 26 contains a number of plates which have a number of small holes that allow the vapour to permeate up through the liquid.

Higher carbon chain oil products such heavy oils and waxes are expected to exit the bottom of the column 26 while oil products with carbon chains of 15 to 25 carbon atoms will exit the middle of the column 26; products associated with these carbon chains include diesel and gas oil. Both these products will be cooled using heat exchangers 35 and 30 and subsequently stored in vessels 36 and 39. A portion of heavy oil exiting the bottom of the column 26 will not be cooled but sent to the extruder 2 through nozzle 6. Another portion of heavy oil exiting the bottom of the column 26 will reheated and reboiled using the reboiler 38 and returned to the column 26.

The non-condensed vapour exiting the top of the column 26 will be cooled further using a condenser 27. The further cooling condenses the naphtha and steam from the remaining hydrocarbon vapour, and the condensate/vapour mixture subsequently enters the three-phase separator 29 which separates the incoming liquid and vapour into three separate streams. The three-phase separator 29 separates naphtha from the water by exploiting the density difference between the two immiscible liquids. The water stream is sent to waste treatment. A portion of the naphtha is pumped using a pump 32 to the column 26 to act as a reflux. The remainder is sent to storage in a tank 47.

The vapour stream exiting the three-phase separator 29 is compressed by a compressor 28 to a pressure over 20 Bar (g) and sent to a gas liquefier.

The compressed vapour stream is cooled to approximately −40° C. by heat exchangers 40 and 41, where heat exchanger 41 is cooled using a low temperature fluid from a refrigeration cycle 42. The stream subsequently enters the first separator 43 of the liquefier. Any liquid 49 that has been condensed falls to the bottom of the separator 43 and the gas flows out of the top. The condensate liquid 49 is pumped to the top of a demethanizer column 48 to absorb the C2 to C4 components. The gas from the top of the separator 43 flows to a second separator 45 after being chilled by a heat exchanger 44 fed by gas exiting the top of a demethaniser column 48, ensuring that most of the liquid is condensed. The gas leaving the top of the second separator 45 is sent to a turbo expander 46 which expands the gas stream and cools the stream. This stream is sent to the demethanizer column 48. The expanding gas spins a shaft that powers a compressor 46a that compresses the top gas leaving the demethanizer column 48. The bottom liquids of the separator 45 enters the bottom of the demethanizer column 48.

The cold two phase stream exits the turboexpander 46 and enters the demethanizer column 48. Upon entering the column 48 the heavier C2 to C4 components condense. The uncondensed light components exiting the top of the demethanizer column 48 are used to cool the incoming feed for the demethanizer column 48 via the heat exchangers 40 and 44. The gas exiting the top of the demethanizer column 48 comprises methane, carbon monoxide and hydrogen; and this gas will then be compressed by the compressor 46a. The liquids leave the bottom of demethanizer 48. These liquids components are composed mainly of C2-C4 products such as ethylene, ethane, propylene, propane, butylene, and butane with small amounts of methane and C5+ components. The liquid can easily be transported to a petrochemical facility where it can be separated into the individual components.

The pressurised gas 66 flowing from the compressor 46a can be sent to a gas engine or turbine to produce electricity, or sent to the regenerator 14 if required as fuel. The gas stream 66 contains mainly methane and hydrogen with small amounts of C2 components. As stream 66 is pressurised it may be combined with high pressure steam so the stream can be steam reformed to produce hydrogen.

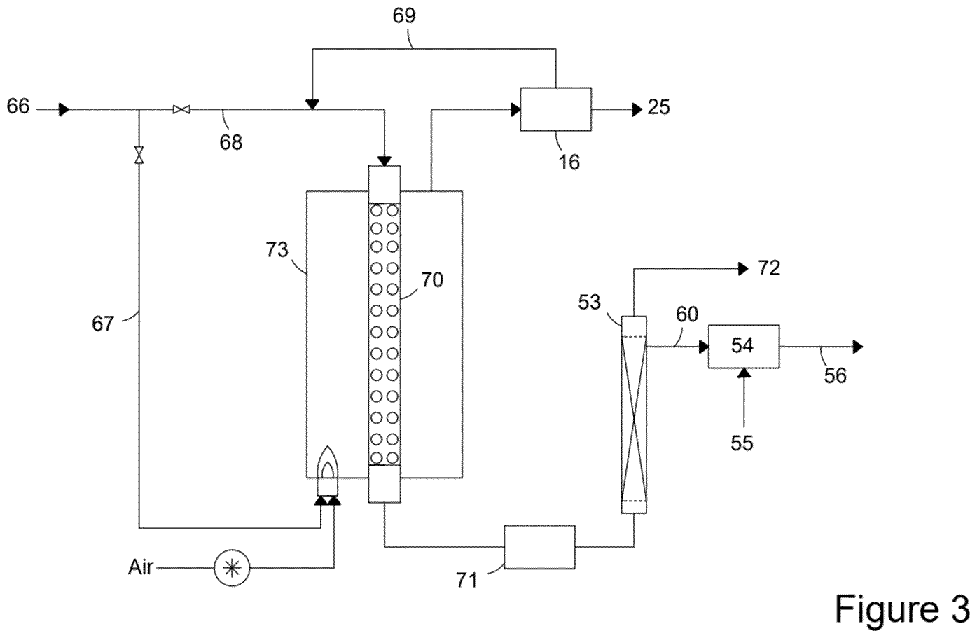

Referring to FIG. 3 this shows the hydrogen generating system. A portion 68 of the uncondensed syngas stream 66 is combined with steam 69 produced by the waste heat boiler 16 and sent to a steam reformer. The steam reformer contains multiple tubes 70 (only one shown) filled with a catalyst located inside a furnace 73 which heats the syngas and steam stream. Another portion 67 of the uncondensed syngas 66 is sent to the burner for the furnace 73. The high temperature and catalyst convert the methane and steam into hydrogen and carbon monoxide. The quantity of hydrogen in the product stream is increased by sending the stream to a water gas shift reactor 71 which converts the carbon monoxide into hydrogen and carbon dioxide by reacting it with water. The resulting stream is pressurised and can be sent to a membrane 53 or any other separation device so that the hydrogen can be separated from the carbon dioxide. This hydrogen stream 60 can optionally be used as a feedstock for a hydrotreatment unit 54 which saturates the olefins contained in the oil products, indicated as 55, by reacting them with hydrogen as well as removing contaminants like sulphur, chlorine, nitrogen and oxygen. The resulting oil 56 from the hydrotreatment unit 54 will be able to meet the strict specifications of the petrochemical industry. The carbon dioxide stream 72 can be a saleable product.

1. An apparatus for pyrolysis of polymeric material, comprising:
an extruder comprising a plurality of counter rotating screws, the extruder being adapted to receive an input polymeric feed and to pre-heat the input polymeric feed, wherein the pre-heating includes shear heating the input polymeric feed with the counter rotating screws to reduce viscosity of the input polymeric feed;
at least one injection nozzle; and a fluidised bed reactor; wherein each injection nozzle is adapted to receive the melted polymeric feed from the extruder, and to spray, atomize and disperse the melted polymeric feed into the fluidised bed reactor, by combining the melted polymeric feed with a high-pressure atomization gas, wherein the fluidised bed reactor is adapted to heat the atomised polymeric feed using upward-flowing heat carrying material in the absence of oxygen to break down the atomised polymeric feed into hydrocarbon vapour and a solid carbon product, each injection nozzle being located towards a bottom of the fluidised bed reactor, and each injection nozzle comprising a first outlet for the melted polymeric feed and a second outlet for the atomisation gas, the first and second outlet ports being arranged such that the corresponding flow paths collide; and a cyclone arranged such that char, heat carrying material and hydrocarbon vapours from the reactor flow to the cyclone, the cyclone being arranged to separate the hydrocarbon vapour from the heat carrying material or char.

2. The apparatus as claimed in claim 1 wherein the injection nozzle comprises at least one outlet for the melted polymeric feed that is of width at least 2 mm in all directions.

3. The apparatus as claimed in claim 2 wherein the outlet is a slot of width between 3 mm and 12 mm, preferably between 4 mm and 10 mm.

4. (canceled)

5. The apparatus as claimed in claim 1, wherein the extruder is adapted to mix a high boiling point product with the input polymeric feed to further reduce the viscosity of the polymeric feed.

6. The apparatus as claimed in claim 1, wherein the extruder is further adapted to:
convert water and halogen contaminants in the input polymeric feed to water vapour and contaminated vapours during pre-heating;
the extruder defining one or more outlets to expel the water vapour and contaminated vapours, wherein the apparatus is adapted to pull vacuum on the melted polymeric feed at at least one such outlet to aid in the removal of the contaminants;
and the extruder defines at least one inlet port to receive a catalyst or a chemical reagent, so the catalyst or chemical reagent is mixed with the melted polymeric feed to neutralise halogens.

7. (canceled)

8. The apparatus as claimed in claim 1, wherein the injection nozzle comprises:
a first passage having an inlet for receiving the melted polymeric feed, and an outlet narrower than the inlet for outputting a thin stream of melted polymeric feed into the fluidised bed reactor; and
second and third passages provided at either sides of the first passage, each having an inlet for receiving atomisation gas, and an outlet for directing the atomisation gas towards the thin stream of melted polymeric feed, wherein the atomisation gas collides with the melted polymeric feed to cause dispersion of small droplets of the melted polymeric feed evenly across the circulating heat carrying material.

9. (canceled)

10. (canceled)

11. (canceled)

12. (canceled)

13. (canceled)

14. A method for pyrolysis of polymeric material, comprising feeding a polymeric feed through an extruder to at least one injection nozzle, the extruder comprising a plurality of counter-rotating screws, wherein the extruder receives the input polymeric feed and melts and pre-heats the input polymeric feed, wherein the pre-heating includes shear heating of the input polymeric feed with the counter rotating screws to reduce viscosity of the melted polymeric feed; each injector nozzle spraying, atomizing and dispersing the melted polymeric feed into a reactor, by combining the melted polymeric feed with a high-pressure atomization gas, wherein the reduced viscosity facilitates even dispersion of the melted polymeric feed, each injection nozzle comprising a first outlet for the melted polymeric feed and a second outlet for the atomization gas, the first and second outlet ports being arranged such that the corresponding flow paths collide; arranging a cyclone such that char, heat carrying material and hydrocarbon vapours from the reactor flow to the cyclone, the cyclone separating the hydrocarbon vapour from the heat carrying material or char.

15. (canceled)

16. An apparatus for treating plastics by pyrolysis in a fluidised bed reactor containing a fluidised bed of particles of heat-carrying material, the apparatus also comprising a cyclone located at a top of the fluidised bed reactor and adapted to separate the heat-carrying material and solid carbon product from a gaseous hydrocarbon product, wherein a gas outlet from the top of the cyclone communicates with a top portion of a steam stripper, and a solid particles outlet from the bottom of the cyclone communicates with a bottom portion of the steam stripper.

17. The apparatus as claimed in claim 16 further comprising a regenerator adapted to combust the solid carbon product on the heat carrying material, wherein the combustion of the solid carbon product leads to reheating of the heat carrying material, before transfer of the heat carrying material to the fluidised bed reactor.

18. The apparatus as claimed in claim 16 further comprising a distillation column downstream of the steam stripper and adapted to condense and separate the hydrocarbon product into different liquid fractions and a gaseous syngas stream.

19. The apparatus as claimed in claim 18 further comprising a gas liquefier to condense C2 to C4 products contained in the gaseous syngas stream.

20. The apparatus as claimed in claim 1 wherein the cyclone is arranged such that the heat carrying material and char fall down into a steam stripping tower adapted to remove the entrained hydrocarbon products in the bed material, desorb any remaining hydrocarbons from the catalytic bed material, and crack any remaining plastic that may have escaped the reactor without cracking.

21. The apparatus as claimed in claim 20 wherein the cyclone is located at the top of the fluidised bed reactor, and wherein a gas outlet at the top of the cyclone communicates with a top portion of the steam stripper and a solid particles outlet from the bottom of the cyclone communicates with a bottom portion of the steam stripper, the apparatus also comprising means to pass steam through the steam stripper to separate and desorb hydrocarbon product adsorbed onto the heat carrying material.

22. The apparatus as claimed in claim 20, further comprising a regenerator adapted to combust the solid carbon product on the heat carrying material, wherein the combustion of the solid carbon product leads to reheating of the heat carrying material to a requisite temperature, before transfer of the heat carrying material to the fluidised bed reactor.

23. The apparatus as claimed in claim 20 further comprising a distillation column or condensing system to treat hydrocarbon product from the fluidised bed reactor and adapted to condense and separate the hydrocarbon product into liquid fractions and a gaseous syngas stream.

24. The apparatus as claimed in claim 23 further comprising a gas liquefier to condense C2 to C4 products contained in the gaseous syngas stream.

25. The apparatus as claimed in claim 24 further comprising a hydrogen separation device adapted to separate hydrogen from resulting uncondensed syngas stream exiting the gas liquefier, and/or
a steam reforming reactor adapted to process a gas stream that is not condensed in the C2 to C4 products, to generate hydrogen

26. The method as claimed in claim 14, wherein the heat carrying material and char fall down into a steam stripping tower, and the method also comprises supplying steam to the steam stripping tower so as to remove the entrained hydrocarbon products in the bed material, desorb any remaining hydrocarbons from the catalytic bed material, and crack any remaining plastic that may have escaped the reactor without cracking.
